(19) United States
(12) Patent Application Publication
(10) Pub. No.: US 2019/0287121 A1
(43) Pub. Date: Sep. 19, 2019

(54) SPECULATIVE CHECK-INS AND IMPORTANCE REWEIGHTING TO IMPROVE VENUE COVERAGE

(71) Applicant: FOURSQUARE LABS, INC., New York, NY (US)

(72) Inventors: Adam Waksman, New York, NY (US); Stephanie Yang, New York, NY (US); Enrique Cruz, New York, NY (US)

(21) Appl. No.: 16/357,749

(22) Filed: Mar. 19, 2019

Related U.S. Application Data
(60) Provisional application No. 62/644,787, filed on Mar. 19, 2018.

(51) Int. Cl. G06Q 30/02; H04W 4/021; H04W 4/33; G06F 17/18; G06N 20/00

(52) U.S. Cl. CPC G06Q 30/0201; G06Q 30/0281; G06Q 30/0202; G06N 20/00; H04W 4/33; G06F 17/18; H04W 4/021

(57) ABSTRACT

Examples of the present disclosure describe systems and methods for visit detection. More particularly, the described systems and methods relate to improving venue coverage distribution as applied to visit detection models. In aspects, the visit detection system/model of a mobile device may predict that a user is visiting a supervenue based on a set of venue visit probabilities. The visit probability for the supervenue may be redistributed among the subvenues of the supervenue to create a subvenue visit probability distribution. Based on the probability redistribution, the visit detection system/model may predict speculatively that the user is visiting (or has checked into) a particular subvenue. Examples of the present disclosure further described an importance reweighting process may be used to correct the bias in data sets used to train/configure the visit detection system/model.

### CROSS-REFERENCE TO RELATED APPLICATIONS

This application claims the benefit of U.S. provisional application Ser. No. 62/644,787, filed Mar. 19, 2018, and entitled “SPECULATIVE CHECK-INS AND IMPORTANCE REWEIGHTING TO IMPROVE VENUE COVERAGE,” which application is incorporated herein by reference in its entirety.

### BACKGROUND

Location intelligence systems are used to enable determinations related to location and visit patterns of mobile devices. In many cases, these systems rely almost exclusively on periodic geographic coordinate data (e.g., latitude, longitude and/or elevation coordinates) to determine the location of a mobile device. However, the almost exclusive use of geographic coordinate data may result in inaccuracies when, for example, multiple locations or venues are within close proximity of each other.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for visit detection. More particularly, the described systems and methods relate to improving venue coverage distribution as applied to visit detection models. In aspects, the visit detection system/model of a mobile device may predict that a user is visiting a supervenue based on a set of venue visit probabilities. The visit probability for the supervenue may be redistributed among the subvenues of the supervenue to create a subvenue visit probability distribution. Based on the probability redistribution, the visit detection system/model may predict speculatively that the user is visiting (or has checked into) a particular subvenue. Examples of the present disclosure further described an importance reweighting process may be used to correct the bias in data sets used to train/configure the visit detection system/model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for visit detection and importance reweighting as described herein.

FIG. 2 illustrates an example input processing system for visit detection and importance reweighting as described herein.

FIG. 3 illustrates an example method for improving the venue coverage of visit detection systems as described herein.

FIG. 4 illustrates an example method for performing importance reweighting for visit detection systems as described herein.

FIG. 5 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

Generally, locations identified as supervenues (e.g., a venue that contains one or more smaller subvenues), such as a shopping mall, an outlet, an airport, or a commercial business building, experience a higher visit rate than singular venues. Because the geographical area occupied by a supervenue is often significantly greater that the geographical area occupied by a singular venue, visit detection systems that only (or primarily) rely on geographic coordinate data to determine location typically assign the supervenue the highest visit probability of any venue within which the user may be located. Although this may be true, when a user visits a supervenue, it is more likely that the user is actually visiting one or more subvenues within the supervenue. Due to the close proximity of the subvenues, the geographic coordinate data used by the visit detection systems may be unable to effectively differentiate between the various subvenues. As a result, the visit detection systems are unable to accurately predict visit locations within a supervenue.

To address such issues, the present disclosure describes systems and methods for improving the granularity and accuracy of venue coverage in visit detection systems, using a speculative check-in and/or importance reweighting process. In aspects, a visit detection system or model may determine a visit probability distribution for a set of venues within a particular area or range of a mobile device. At least one visit probability in the visit probability distribution may correspond to a supervenue. A supervenue, as used herein, may refer to a venue that contains one or more smaller subvenues. Example supervenues include, but are not limited to, shopping malls, marketplaces, airports, and commercial business buildings. In some aspects, if the visit detection system/model determines that the supervenue has the highest visit probability for the set of venues, the mobile device may be determined to be located at the supervenue. Upon making this determination, the visit detection system/model may redistribute the visit probability assigned to the supervenue among the subvenues of the supervenue to create a subvenue visit probability distribution. Based on this subvenue visit probability redistribution, the visit detection system/model may generate a ranked set of subvenues and/or output a predicted subvenue location (e.g., a speculative check-in). In examples, the redistribution of the probability distribution may enable the visit detection system/model to identify and/or suggest subvenues that may not have been previously suggested (at least in part because the previously suggested venue would have been the supervenue). Further, the redistribution enables the visit detection system/model to speculatively explore and collect labeled data (e.g., confirmed suggestions) on a wider set of venues that would otherwise be under-represented, while maintaining a high level of accuracy for venue prediction.

The present disclosure further describes systems and methods for importance reweighting. Importance reweighting, as used herein, may refer to un-skewing or de-biasing of data by applying weights to the training data set that is ultimately provided to a visit detection model. In aspects, importance reweighting may be used to minimize or eliminate the effects of data skewing resulting from providing a visit detection model with data derived mostly from popular and frequently visited locations. Generally, because more people visit popular venues more often than unpopular venues, popular venues are over-represented in a visit probability distribution. Accordingly, a visit detection model provided with data derived primarily from visits to popular venues would reflect a bias towards those popular locations in the probability distribution. Importance reweighting, thus, modifies a skewed training data set to reflect a more accurate representation of a visit probability distribution, and a wider scope of venues that may otherwise be under-represented.

Accordingly, the present disclosure provides a plurality of technical benefits including but not limited to: improving venue coverage for visit detection systems; identifying supervenues and corresponding subvenues; generating venue visit probabilities distributions for supervenues and subvenues; redistributing the visit probability of a supervenue among the subvenues of that supervenue; calculating one or more speculative check-ins; and eliminating/minimizing data biasing towards popular venues using a venue importance reweighting process, among other examples.

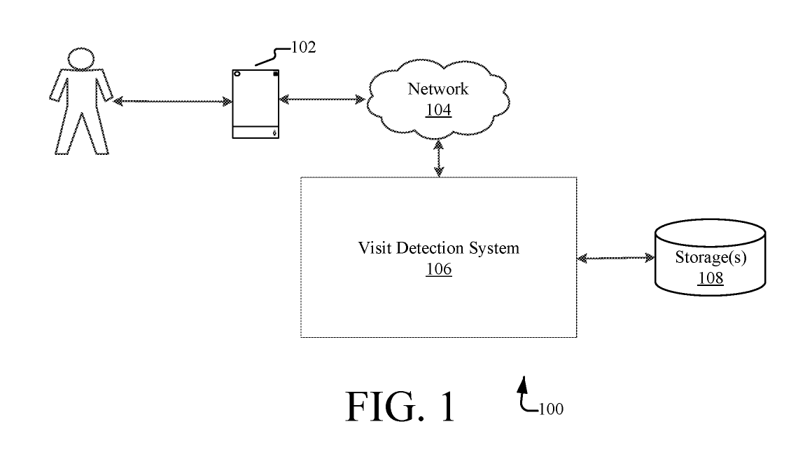

FIG. 1 illustrates an overview of an example system for visit detection and importance reweighting as described herein. Example system 100 presented is a combination of interdependent components that interact to form an integrated whole for venue detection systems. Components of the systems may be hardware components or software implemented on and/or executed by hardware components of the systems. In examples, system 100 may include any of hardware components (e.g., used to execute/run operating system (OS)), and software components (e.g., applications, application programming interfaces (APIs), modules, virtual machines, runtime libraries, etc.) running on hardware. In one example, an example system 100 may provide an environment for software components to run, obey constraints set for operating, and utilize resources or facilities of the system 100, where components may be software (e.g., application, program, module, etc.) running on one or more processing devices. For instance, software (e.g., applications, operational instructions, modules, etc.) may be run on a processing device such as a computer, mobile device (e.g., smartphone/phone, tablet, laptop, personal digital assistant (PDA), etc.) and/or any other electronic devices. In other examples, the components of systems disclosed herein may be distributed across multiple devices. For instance, input may be entered on a client device and information may be processed or accessed from other devices in a network, such as one or more server devices.

As one example, the system 100 comprises computing device 102, distributed network 104, visit detection system 106, and storage(s) 108. One of skill in the art will appreciate that the scale of systems such as system 100 may vary and may include more or fewer components than those described in FIG. 1. In some examples, interfacing between components of the system 100 may occur remotely, for example, where components of system 100 may be distributed across one or more devices of a distributed network.

Computing device 102 may be configured to collect sensor data related to one or more locations or venues. In aspects, client device 102 may comprise, or have access to, one or more sensors. The sensors may be operable to detect and/or generate sensor data for client device 102, such as GPS coordinates and geolocation data, positional data (such as horizontal and/or vertical accuracy), Wi-Fi information, OS information and settings, hardware information, signal strengths, accelerometer data, time information, etc. Client device 102 may access, collect, and/or store the sensor data. In one example, client device 102 may store the data locally, remotely, or some combination thereof. For instance, sensitive user information such as user, account and/or device identifying information may be stored on a client device, whereas location and movement may be stored in a distributed storage system. In some aspects, client device 102 may collect and/or store sensor data in response to detecting an event, a location, or the satisfaction of one or more criteria. For instance, sensor data may be collected from a set of sensors in response to a movement event (e.g., an acceleration, a directional modification, prolonged idling, etc.) by client device 102. In examples, detecting a stop may include the use of one or more machine learning (ML) techniques or algorithms, such as expectation-maximization (EM) algorithms, Hidden Markov Models (HMMs), Viterbi algorithms, forward-backward algorithms, fixed-lag smoothing algorithms, Baum-Welch algorithms, etc.

Visit detection system 106 may be configured to evaluate a set of sensor data. In aspects, visit detection system 106 may have access to one or more sets of sensor data. For example, client device 102 may transmit the sensor data, or a representation thereof, to visit detection system 106. In another example, the sensor data may be collected from a data store, such as storage(s) 108. In yet another example, the sensor data may be input directly into visit detection system 106. For instance, visit analysis detection 106 may provide, or have access to, an interface (such as an application or service) for interacting with sensor data. The interface may be used to enter data sets comprising user data and/or training data, and assign labels correlating the data sets to one or more corresponding events (e.g., entering a venue, exiting a venue, suspending transit, analyzing a promotional item, etc.). In some aspects, the sensor data and/or the labeled event data may be provided to a data analysis component or utility (not illustrated). The data analysis component/utility (or portions thereof) may be located on client device 102 and/or one or more separate devices, such as visit detection system 106. In examples, the data analysis component/utility may process the labeled or unlabeled sensor data to identify one or more location and/or movement events. Processing the sensor data may comprise parsing and identifying sensor data comprising geographical location data (e.g., latitude, longitude, elevation coordinates, etc.), Wi-Fi information (e.g., network frequency, mac address, signal strength, service set identifier (SSID), timestamps, etc.) and/or movement data (e.g., acceleration events, velocity information, etc.).

In aspects, visit detection system 106 may additionally comprise, or have access to, one or more predictive models and/or algorithms. Exemplary models/algorithms include expectation-maximization (EM) algorithms, Hidden Markov Models (HMIMs), Viterbi algorithms, forward-backward algorithms, fixed-lag smoothing algorithms, Baum-Welch algorithms, etc. The predictive models may be operable to determine visit detection information. For example, the predictive models may access a set of unlabeled data comprising events and corresponding sensor data. The data analysis engine may use the set of unlabeled data as input to an EM algorithm associated with a predictive model. An EM algorithm, as used herein, may refer to an iterative method for finding maximum likelihood or maximum a posteriori (MAP) estimates of parameters in statistical models, where the model depends on unlabeled data. The EM algorithm may use the set of unlabeled data to train the predictive models to detect when a mobile device user is visiting a venue. As another example, the predictive models may access a set of labeled data comprising labeled events and corresponding sensor data. The data analysis engine may use the set of labeled data as input to an HMM. An HMM, as used herein, may refer to a time series model for which a set of observed values are driven by a set of hidden states having Markov transitions. The MINI may use the set of labeled data to determine the most applicable parameter(s)/feature(s) in the set of labeled data (or to retune an existing set of parameter(s)/feature(s)). The determined parameter(s)/feature(s) may then be used to detect when a mobile device user is visiting a venue, or as an initialization point for, for example, an EM algorithm.

Visit detection system 106 may be further configured to generate visit probabilities for a set of venues. In aspects, the predictive models and/or algorithms accessed by visit detection system 106 may be used to generate a set of visit probabilities for one or more venues. The visit probabilities may be ranked (e.g., highest to lowest) and may indicate the probability that a user visited a specific venue within a particular area or range of client device 102. In some aspects, at least one of the visit probabilities may correspond to a supervenue. When that supervenue is determined to be the highest ranked venue (or within a set of highest ranked venues), visit detection system 106 may determine that client device 102 is located at the supervenue. Upon determining that client device 102 is located at the supervenue, visit detection system 106 may redistribute the visit probability assigned to the supervenue among the subvenues of the supervenue to create a subvenue visit probability distribution. Based on this subvenue visit probability redistribution, visit detection system 106 select a subvenue at which a user is most likely located (e.g., a speculative check-in). Visit detection system 106 may provide at least the selected subvenue using, for example, the interface described above. In some aspects, the interface may enable a user to provide feedback for the selected subvenue. For example, the user may confirm, deny, or edit the selected subvenue. The feedback may then be used to improve the accuracy of the predictive models and/or algorithms, and to expand the set of venues available for analysis.

Visit detection system 106 may be further configured to perform importance reweighting for data provided to the predictive models and/or algorithms. In aspects, visit detection system 106 may train the predictive models and/or algorithms using one or more data sets. Prior to (or during) the training, visit detection system 106 may apply a set of one or more weights to the data set(s) to minimize or eliminate the skewing effects of data over-representing one or more venues/locations, venue/location types, or venues/locations having certain attributes. As a particular example, a data set derived mostly from popular and/or frequently visited locations may, as a result, over-represent popular and/or frequently visited locations. To correct such an over-representation, weighting factors and/or weighting functions may applied to one or more data points in the data set to decrease the importance of popular and frequently visited locations, or to increase the importance of unpopular and infrequently visited locations. In aspects, the weights may be applied to a data set using, or according to, an ML approach, a rule set, or other decision logic. For example, ML techniques may be used to reweight a data set such that the reweighted data set represents a statistical distribution consistent with Zipf's Law.

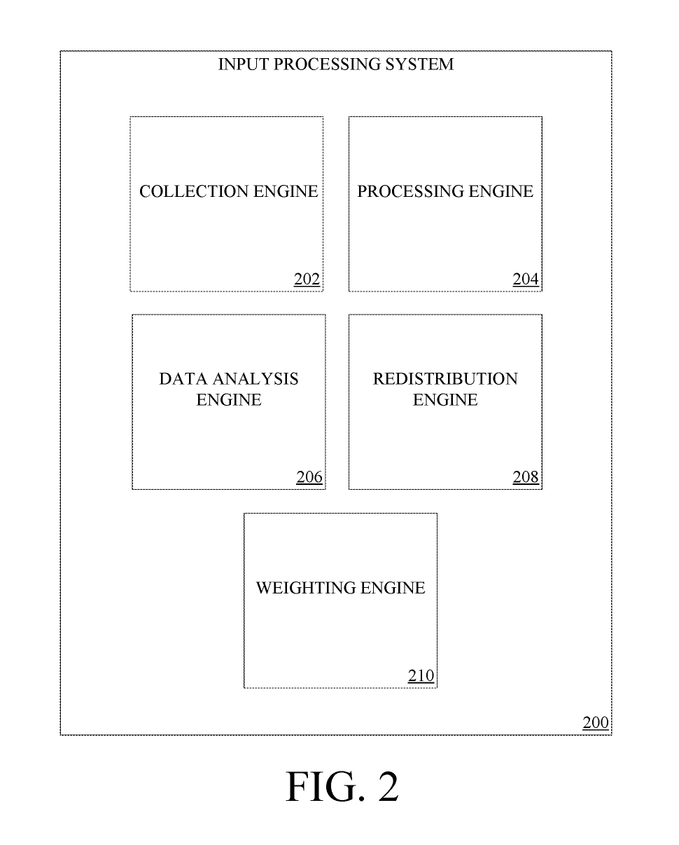

FIG. 2 illustrates an overview of an example input processing system 200 for visit detection and importance reweighting, as described herein. The visit detection and reweighting techniques implemented by input processing system 200 may comprise the visit detection and reweighting techniques and content described in FIG. 1. In alternative examples, a single system (comprising one or more components such as processor and/or memory) may perform processing described in systems 100 and 200, respectively.

With respect to FIG. 2, input processing system 200 may comprise collection engine 202, processing engine 204, data analysis engine 206, redistribution engine 208, and weighting engine 210. Collection engine 202 may be configured to collect or receive sensor data. In aspects, collection engine 202 may have access to one or more data sources that comprise and/or generate sensor data. The sensor data may represent input from a user or physical environment associated with one or more mobile devices. The data sources may be stored locally on input processing system 200 or remotely on one or more computing devices. In some aspects, the data source(s) may transmit sensor data to collection engine 202 (or collection engine 202 may retrieve data from the data source(s)) continuously, at periodic intervals, on demand, or upon the satisfaction one or more criteria. In at least one aspect, collection engine 202 may provide, or have access to, an interface. The interface may enable a user to enter sensor data and data associated therewith. The interface may further provide for navigating and manipulating the data. For example, a user may use the interface to enter or upload a set of sensor data to collection engine 202. The set of sensor data may comprise labeled and or unlabeled data. The interface may enable the user to view the sensor data, assign labels to (or otherwise annotate) the sensor data and/or modify or remove the labels.

Processing engine 204 may be configured to process sensor data. In aspects, processing engine 204 may have access to collected sensor data. Processing engine 204 may process the labeled or unlabeled sensor data to identify one or more location and/or movement events. Processing the sensor data may comprise parsing and identifying sensor data comprising geographical location data (e.g., latitude, longitude, elevation coordinates, etc.), Wi-Fi information (e.g., network frequency, mac address, signal strength, service set identifier (SSID), timestamps, etc.), movement data (e.g., acceleration events, velocity information, etc.), etc. Processing the sensor data may additionally or alternately comprise evaluating labeled sensor data to identify and organize labels and corresponding sensor features into one or more groups. The sensor features may represent or correspond to one or more motion states, and may include data such as speed/velocity over an ‘X’ second time period, acceleration, distance from a previous point, Wi-Fi signal strength, etc. In aspects, the parsed sensor data may be used to generate one or more feature vectors. A feature vector, as used herein, may refer to an n-dimensional vector of numerical features that represent one or more objects. The feature vectors may comprise features of the sensor data and/or information from one or more knowledge sources or data stores. For example, a feature vector may comprise Wi-Fi information for one or more venues, promotional items corresponding to the venues, movement/displacement data for a mobile device, user venue check-in data, purchase date, event duration data, etc.

Data analysis engine 206 may be configured to determine mobile device location and/or whether a visit/stop event has occurred. In aspects, data analysis engine 206 may have access to one or more feature vectors or feature sets. Data analysis engine 206 may apply the feature vectors/sets to one or more statistical or predictive models/algorithms. Exemplary models/algorithms include expectation-maximization (EM) algorithms, Hidden Markov Models (HMMs), Viterbi algorithms, forward-backward algorithms, fixed-lag smoothing algorithms, Baum-Welch algorithms, Kalman filtering/linear quadratic estimation (LQE), etc. The models/algorithms may be located on input processing system 200, on one or more remote devices, or some combination thereof. For example, a first set of models/algorithms may be implemented on input processing system 200 to process/evaluate sensor data in real time, and a second set of models/algorithms may be implemented on one or more remote server devices to perform model training and big data analysis offline (or periodically). One or more models/algorithms may be in the first and second set of models/algorithms.

In aspects, the models/algorithms may be operable to determine (or may be trained to determine) visit detection information and/or venue detection information. For example, data analysis engine 206 may provide a feature vector/set to a model/algorithm operable to classify the various data points of a feature vector/set into ‘N’ classes or clusters. The classes may correspond to motion at various speeds (e.g., not moving, moving slowly, moving, moving quickly, etc.). The model/algorithm may evaluate the classes (or data therein) against the sensor data to correlate data points in the classes to motion states (e.g., moving, stopped, visiting, etc.). Alternately, the model/algorithm may provide the classes and associated data to a separate model/algorithm to perform the correlation. In aspects, the models/algorithms may identify a set of venues in an area surrounding a determined mobile device location. A venue visit probability distribution may be generated for the set of venues using, for example, one or more gradient boosting techniques and/or an ensemble of decision trees. The venue visit probability distribution may represent the probability or confidence that a mobile device is located at a particular venue. The gradient boosting techniques may incorporate factors such as venue age, venue popularity, proximity to other venues, historical accuracy of venue choices/selections, previous venue visits, etc. In at least one example, gradient boosting techniques may also incorporate explicit user feedback. The models/algorithms may rank the set of venues according to the probability distribution (e.g., highest to lowest probability). Based on the rankings, one or more venues may be selected and provided as a probable visit location.

Redistribution engine 208 may be configured to redistribute supervenue visit probabilities. In aspects, redistribution engine 208 may be provided a set of one or more venues and/or corresponding visit probabilities. For each venue (or for only the highest ranked venue), redistribution engine 208 may identify whether the venue is a supervenue. In examples, determining whether a venue is a supervenue may include querying a venue directory or service, performing a venue/location lookup operation, or the like. In some aspects, upon identifying a venue is a supervenue, a set of subvenues for the supervenue may be identified. A venue visit probability distribution may be generated for the set of subvenues by redistributing the visit probability of the corresponding supervenue among the set of subvenues. In examples, redistributing the visit probability of the supervenue may include applying the gradient boosting techniques described above and/or generating probabilities or confidence scores to each subvenue using, for example, a probability density function. Redistribution engine 208 may rank the set of subvenues according to the probability distribution (e.g., highest to lowest probability). Based on the rankings, one or more subvenues may be selected and provided as a probable visit location. In at least one example, a mobile device may be considered to be speculatively checked into a selected subvenue/probable visit location.

Weighting engine 210 may be configured to reweight data sets used to train the models/algorithms. In aspects, weighting engine 210 may have access to a data set comprising labeled and/or unlabeled data. Weighting engine 210 may apply one or more weighting factors and/or weighting functions to the data set to minimize or eliminate the skewing effects of over-represented data. For example, weighting engine 210 may apply a reweighting approach that compensates for the importance of venues that are unpopular are infrequently visited. Such a reweighting approach may place a greater emphasis on correctly identifying unpopular/infrequently visited venues than correctly identifying popular are frequently visited venues. As a result, when the reweighted data set is provided to the models/algorithms described above, the models/algorithms may be biased toward the selection of under-represented venues when the probability for an under-represented venue and an over-represented venue are close. This bias enables the models/algorithms to efficiently increase distinct venue detection while maintaining high detection accuracy for popular and frequently visited venues.

Having described various systems that may be employed by the aspects disclosed herein, this disclosure will now describe one or more methods that may be performed by various aspects of the disclosure. In aspects, methods 300 and 400 may be executed by a visit detection system, such as system 100 of FIG. 1 or system 200 of FIG. 2. However, methods 300 and 400 are not limited to such examples. In other aspects, methods 300 and 400 may be performed on an application or service for performing visit detection. In at least one aspect, methods 300 and 400 may be executed (e.g., computer-implemented operations) by one or more components of a distributed network, such as a web service/distributed network service (e.g. cloud service).

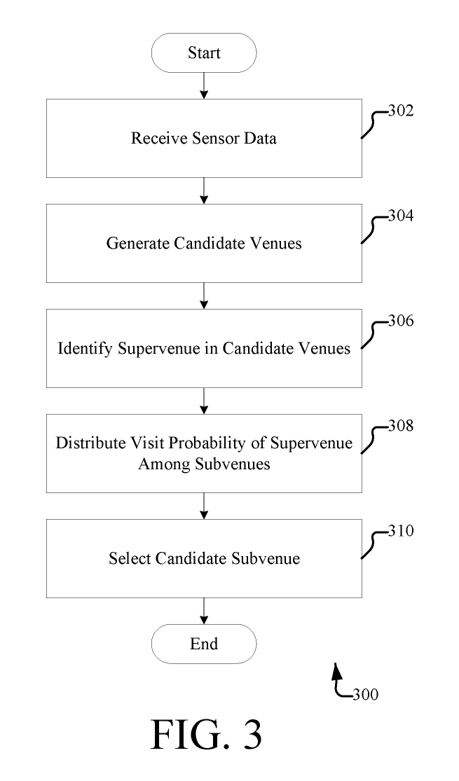

FIG. 3 illustrates an example method 300 for improving the venue coverage of visit detection systems, as described herein. Example method 300 begins at operation 302, where sensor data may be received. In aspects, sensor data from one or more sensors of (or associated with) a mobile device, such as client device 102, may be monitored or collected. The sensor data may comprise information associated with GPS coordinates and geolocation data, positional data (such as horizontal accuracy data, vertical accuracy data, etc.), Wi-Fi data, over the air (OTA) data (e.g., Bluetooth data, near field communication (NFC) data, etc.), OS information and settings, hardware/software information, signal strength data, movement information (e.g., acceleration, time and directional data), etc. The sensor data may be collected continuously, intermittently, upon request, or upon the satisfaction of one or more criteria, such as a detected stop, an appreciable change in movement velocity and/or direction, a check-in, a purchase event, the receipt of a message by the mobile device, or the like.

At operation 304, a set of candidate venues may be generated. In aspects, the sensor data of a mobile device may be accessible to a venue prediction utility, such as data analysis engine 206. The venue prediction utility may parse the sensor data to identify venues and/or associated venue data. The venue data may be applied to a model or algorithm usable for venue-identification. For example, the venue data may be applied to a classification algorithm, such as a k-nearest neighbor algorithm. The classification algorithm may use the venue data to identify candidate venues that are within a specific proximity or density distribution of a location reported for a mobile device. For instance, the classification algorithm may utilize a geographical mapping service to identify a set of venues within 500 feet of a set of geographical coordinates. In at least one example, the classification algorithm may further incorporate factors such as venue popularity, venue visit recency, venue ratings, sales data (regional, seasonal, etc.), user preference data, etc. In aspects, a probability distribution may be generated for the candidate venues. The probability distribution may indicate the probabilities that a user is visiting, checked into, or otherwise located at each of the candidate venues. The candidate venues may be ranked according to the probability distribution, and a highest ranked candidate venue (or a set of top ‘X’ candidate venues) may be selected as the most likely location of the mobile device.

At operation 306, a supervenue may be identified. In aspects, a venue evaluation utility, such as redistribution engine 208, may be used to determine whether a selected candidate venue (e.g., a highest ranked candidate venue) is a super venue. The determination may include the use of, for example, a venue lookup operation or a predefined venue mapping. When a selected candidate venue is determined to be a supervenue, a set of subvenues (and/or supervenues) for the supervenue may be identified and the relationships between the various venues may be recorded. For example, a tree diagram comprising various venues, their respective supervenues and subvenues, and the corresponding venue probabilities for each venue may be generated and stored in data store, such as storage(s) 108.

At operation 308, a supervenue visit probability may be distributed among corresponding subvenues. In aspects, the visit probability for a supervenue may be redistributed among the set of corresponding subvenues to generate a subvenue probability distribution. The subvenue probability distribution may represent the probability that a user is visiting, checked into, or otherwise located at each of the subvenues. Redistributing the visit probability for the supervenue may comprise one or more gradient bosting techniques incorporating factors such as venue age, venue popularity, proximity to other venues, historical accuracy of venue choices/selections, previous venue visits, user feedback, etc. As a particular example, a visit probability distribution for a set of candidate venues may indicate that store A (single venue) has a visit probability of 5%, store B (supervenue) has a visit probability of 80%, and store C (supervenue) has a visit probability of 15%. After determining that store is a supervenue comprising the four subvenues store B1, store B2, store B3, and store B4, the 80% visit probability for store B may be redistributed among the four subvenues such that store B1 is assigned a visit probability of 5%, store B2 is assigned a visit probability of 10%, store B3 is assigned a visit probability of 40%, and store B4 is assigned a visit probability of 25%. In such an example, a data structure (such as a venue tree diagram) may be generated or updated to reflect the redistribution of the visit probability for a supervenue. For instance, the visit probability distribution for the set of candidate venues may be updated to indicate that store A (single venue) has a visit probability of 5%, B1 is assigned a visit probability of 5%, store B2 is assigned a visit probability of 10%, store B3 is assigned a visit probability of 40%, store B4 is assigned a visit probability of 25%, and store C (supervenue) has a visit probability of 15%. Alternately, the visit probability distribution for the set of candidate venues may be additionally updated to indicate the visit probabilities for the subvenues of store C, which is a supervenue.

At operation 310, a candidate subvenue may be selected. In aspects, the subvenue probability distribution may be used to generate a set of candidate subvenues. The set of candidate subvenues may be ranked according to the subvenue probability distribution. For example, the set of candidate subvenues may be ranked from highest to lowest probability. In some aspects, the highest ranked candidate subvenue (or a set of top ‘X’ highest ranked candidate subvenues) may be selected as the most likely location of the mobile device. As a result, a speculative check-in may be performed and/or recorded for the selected subvenue(s). For example, in response to determining that store A of a supervenue is the most likely location of the mobile device, a visit detection system may generate an indication that the mobile device is visiting or checked into store A.

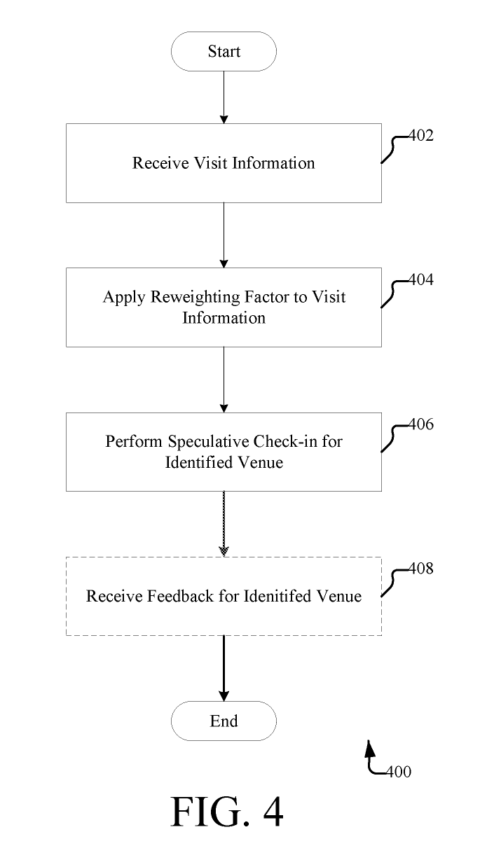

FIG. 4 illustrates an example method 400 for performing importance reweighting for visit detection systems, as described herein. Example method 400 begins at operation 402, where visit information is received. In aspects, a weighting analysis component of a visit detection system, such as weighting engine 210, may have access to a set of labeled and/or unlabeled visit information. The visit information may comprise, for example, user and/or device identification data, user demographic data, user visit and/or stop data, user check-in data, location data, date/time data, user behavior data, explicit user feedback, or the like. In examples, the visit information may over-represent and/or under-represent particular types of venues/locations or venues/locations having certain attributes. For instance, because people visit popular venues more often than unpopular venues, popular and frequently visited venues may be over-represented in a set of visit information. As a result, a visit detection model provided with this visit information may bias visit probabilities toward the over-represented venues. That is, the visit detection model may place too much importance on over-represented venues when determining mobile device locations.

At operation 404, a reweighting factor may be applied to the visit information. In aspects, one or more weighting factors and/or weighting functions may be applied to data points in the visit information. The data points may correspond to visit probabilities, venue visit totals, implicit and explicit check-in totals, check-in frequencies, or the like. The weighting factors/functions may be configured to decrease the bias toward over-represented venues using, or according to, an ML approach, a rule set, or other decision logic. For example, an ML model may apply a weighting factor to visit information to create a visit probability distribution that approximates Zipf's law. The weighting factor may be applied in such a manner that the aggressiveness of the reweighting may be tuned and controlled using, for example, an interactive slide control. The weighting factors/functions may be further configured to motivate a visit detection model to apply weights that reward the visit detection model more heavily for accurately predicting new, unpopular, or infrequently visited venues. In examples, applying weighting factors/functions to visit information may produce a set of visit information comprising a wider array of venues and reflecting a more accurate representations of venue visitation.

At operation 406, a speculative check-in may be performed based on the reweighted visit information. In aspects, a set of reweighted visit information may be provided to a venue/visit analysis utility, such as data analysis engine 206. The venue/visit analysis utility may provide the set of reweighted visit information to one or more visit detection models. In response, the visit detection model(s) may output a set candidate venues and/or a visit probability distribution for the reweighted visit information. The set of candidate venues may be ranked according to the visit probability distribution. In some aspects, the set of candidate venues (or some portion thereof) may be evaluated to determine whether the any of the candidate venues are supervenues. For one or more of the identified supervenues, a corresponding list of subvenues may be identified. The visit probability of the supervenue may be distributed among the respective subvenues of the supervenue. A subvenue having the highest visit probably (or satisfying another criteria) may be identified. The identified subvenue may be provided to a user as a probable visit location and/or used to perform a speculative check-in by the visit detection system.

At optional operation 408, feedback for the identified subvenue may be received. In aspects, the visit detection system may provide or have access to an interface of the mobile device. The interface may be configured to enable a user to view, hear, or otherwise interact with an identified subvenue. The interface may be further configured to enable a user to provide feedback relating to the identified subvenue. For example, the interface may enable a user to confirm, deny, or edit an identified subvenue. The feedback may be provided to the visit detection model to improve the accuracy of the visit detection model and expand the set of venues available for evaluation by the visit detection model.

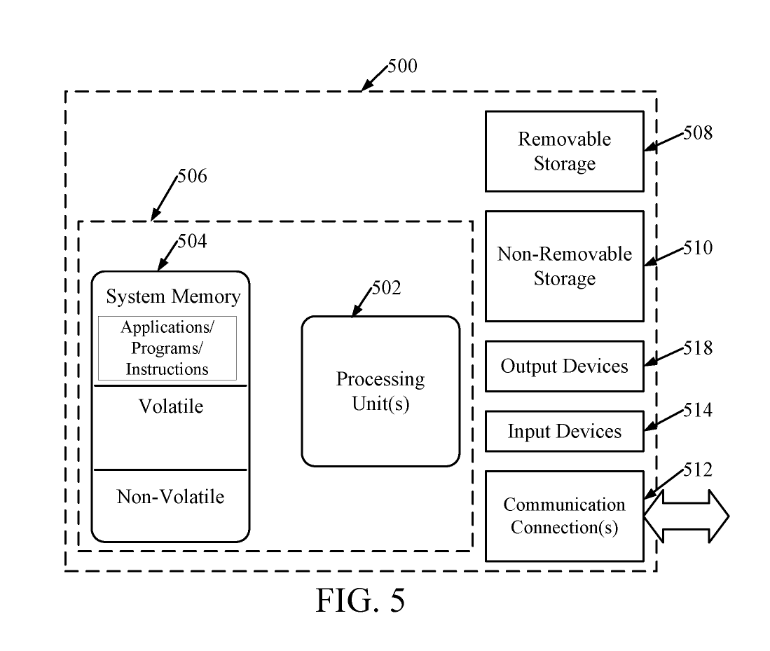

FIG. 5 illustrates an exemplary suitable operating environment for the venue detection system described in FIG. 1. In its most basic configuration, operating environment 500 typically includes at least one processing unit 502 and memory 504. Depending on the exact configuration and type of computing device, memory 504 (storing, instructions to perform the speculative check-in and importance reweighting techniques disclosed herein) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as keyboard, mouse, pen, voice input, etc. and/or output device(s) 516 such as a display, speakers, printer, etc. Also included in the environment may be one or more communication connections, 512, such as LAN, WAN, point to point, etc. In embodiments, the connections may be operable to facility point-to-point communications, connection-oriented communications, connectionless communications, etc.

Operating environment 500 typically includes at least some form of computer readable media. Computer readable media can be any available media that can be accessed by processing unit 502 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments are described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A system comprising:
one or more processors; and
memory coupled to at least one of the one or more processors, the memory comprising computer executable instructions that, when executed by the at least one processor, performs a method comprising:
receiving sensor data for a mobile device, wherein the sensor data relates to one or more locations;
generating a set of candidate venues based on the sensor data, wherein the set of candidate venues are associated with respective visit probabilities;
identifying a supervenue in the set of candidate venues, wherein the supervenue comprises one or more subvenues;
distributing a visit probability of the supervenue among the one or more subvenues to create a set of subvenue visit probabilities; and
selecting a subvenue from the one or more subvenues based on the set of subvenue visit probabilities.

2. The system of claim 1, wherein the sensor data comprises at least one of geolocation coordinates and Wi-Fi information.

3. The system of claim 1, wherein the set of candidate venues are determined to be within a specific proximity of a location of the mobile device.

4. The system of claim 1, wherein generating the set of candidate venues comprises generating a visit probability distribution for the set of candidate venues.

5. The system of claim 4, wherein generating the set of candidate venues further comprises:
ranking the set of candidate venues according to the visit probability distribution; and
selecting a highest ranked candidate venue from the set of candidate venues, wherein the highest ranked candidate venue is the supervenue.

6. The system of claim 4, wherein the set of candidate venues is generated using one or more gradient boosting technique.

7. The system of claim 1, wherein identifying the supervenue comprises using at least one of a venue lookup operation or a predefined venue mapping.

8. The system of claim 1, wherein creating the set of subvenue visit probabilities comprises ranking the one or more subvenues based on the set of subvenue visit probabilities.

9. The system of claim 1, wherein the selected subvenue is highest ranked among the ranked one or more subvenues.

10. The system of claim 1, wherein a speculative check-in is performed for the selected subvenue.

11. A system comprising:
one or more processors; and
memory coupled to at least one of the one or more processors, the memory comprising computer executable instructions that, when executed by the at least one processor, performs a method comprising:
receiving visit data, wherein the visit information comprises check-in data for one or more venues;
applying a reweighting factor to the visit information to create reweighted visit information; and
based on the reweighted visit information, performing a speculative check-in for a venue.

12. The system of claim 11, wherein the visit data over-represents one or more types of venues.

13. The system of claim 12, wherein the one or more types of venues correspond to at least one of popular venues and frequently visited venues.

14. The system of claim 12, wherein the applying the reweighting factor minimizes the effect of the over-represented one or more types of venues.

15. The system of claim 11, wherein the reweighting factor is applied, using a machine learning (ML) model, to at least one of visit probabilities, visit counts, and check-in counts.

16. The system of claim 11, wherein the applying the reweighting factor creates a visit probability distribution approximating Zipf's Law.

17. The system of claim 11, the method further comprising:
providing the reweighted visit information to a visit detection model;
receiving, from the visit detection model, a set of candidate venues;
identifying a supervenue in the set of candidate venues; and
redistributing a visit probability for the supervenue to one or more subvenues of the supervenue to create a subvenue visit probability distribution.

18. The system of claim 17, the method further comprising:
ranking the one or more subvenues according to the subvenue visit probability distribution;
selecting a highest ranked subvenue from the one or more subvenues; and
performing the speculative check-in for the highest ranked subvenue.

19. The system of claim 1, the method further comprising:
presenting, via an interface, the venue;
receiving, via the interface, feedback relating to the venue; and
providing at least a portion of the feedback to a visit detection model.

20. A method comprising:
receiving sensor data for a mobile device, wherein the sensor data relates to one or more locations;
generating a set of candidate venues based on the sensor data, wherein the set of candidate venues are associated with respective visit probabilities;
identifying a supervenue in the set of candidate venues, wherein the supervenue comprises one or more subvenues;
distributing a visit probability of the supervenue among the one or more subvenues to create a set of subvenue visit probabilities; and
selecting a subvenue from the one or more subvenues based on the set of subvenue visit probabilities
